(19) United States
(12) Patent Application Publication
(10) Pub. No.: US 2026/0351982 A1
(43) Pub. Date: Nov. 5, 2026

(54) CONTROL DEVICE, POWER CONVERSION DEVICE, CONTROL METHOD FOR POWER CONVERSION DEVICE AND PROGRAM

(71) Applicant: TMEIC Corporation, Tokyo (JP)

(72) Inventors: Yoshihiro TAWADA, Tokyo (JP); Kenta YAMABE, Tokyo (JP); Issei FUKASAWA, Tokyo (JP); Mohammad BANI SHAMSEH, Tokyo (JP)

(73) Assignee: TMEIC Corporation, Tokyo (JP)

(21) Appl. No.: 18/997,612

(22) PCT Filed: Jul. 18, 2023
(86) PCT No.: PCT/JP2023/026293

§ 371 Date: Jan. 22, 2025

(51) Int. Cl. H02J 3/38; H02J 3/001; H02J 3/46; H02J 101/24; H02M 1/32; H02M 7/5387

(52) U.S. Cl. CPC H02J 3/381; H02J 3/001; H02J 3/46; H02J 2101/24; H02M 1/32; H02M 7/53871

(57) ABSTRACT

A control device according to the present disclosure includes a first conversion circuitry configured to perform conversion for positive sequence d and q-axis current command values and outputs positive sequence current command values of three phases; a second conversion circuitry configured to perform the conversion for negative sequence d and q-axis current command value and outputs negative sequence current command values of the three phases; an addition circuitry configured to add the positive and negative sequence current command values and outputs current command values of the three phases; and an amplitude correction circuitry configured to calculate amplitude values of the three phases and perform correction such that amplitudes of the current command values of the three phases do not exceed a specified value in a case where a maximum amplitude value among the amplitude values of the three phases exceeds the specified value which is defined in advance.

### TECHNICAL FIELD

The present disclosure relates to a control device, a power conversion device, a control method for a power conversion device and a program.

### BACKGROUND ART

PTL 1 discloses a power conversion device that includes a power conversion circuit, which is constructed so as to convert a direct-current power to three-phase alternating-current power in accordance with a switching control signal, and a power conversion control circuit. The power conversion control circuit calculates a positive sequence current command signal based on a positive sequence voltage of a three-phase alternating-current output voltage and a positive sequence current of a three-phase alternating-current output current. The power conversion control circuit performs dq conversion for each of a measured value of the three-phase alternating-current output voltage and a measured value of the three-phase alternating-current output current. Accordingly, a first axis negative sequence voltage value as a d-axis component of a negative sequence voltage, a second axis negative sequence voltage value as a q-axis component of the negative sequence voltage, a first axis negative sequence current value as a d-axis component of a negative sequence current, and a second axis negative sequence current value as a q-axis component of the negative sequence current are calculated. The power conversion control circuit calculates a first axis negative sequence current command value as a d-axis component command in the negative sequence current based on the second axis negative sequence voltage value and calculates a second axis negative sequence current command value as a q-axis component command in the negative sequence current based on the first axis negative sequence voltage value. The power conversion control circuit calculates a negative sequence current command signal based on the first axis negative sequence current command value, the second axis negative sequence current command value, the first axis negative sequence current value, and the second axis negative sequence current value and generates a switching control signal based on the positive sequence current command signal and the negative sequence current command signal.

### CITATION LIST

### Patent Literature

[PTL 1] Japanese Patent No. 6819818

### SUMMARY OF THE INVENTION

### Problems to be Solved by the Invention

In PTL 1, a signal which results from the summation of a positive sequence current command signal and a negative sequence current command signal is used as a current command value for controlling a power conversion circuit. In this case, depending on a phase relationship between a positive sequence and a negative sequence, an amplitude of the current command value resulting from the summation might become excessively large.

An object of the present disclosure is to obtain a control device, a power conversion device, a control method for a power conversion device and a program that can restrict an amplitude of a current command value to an arbitrary value.

### Solution to Problem

A control device according to the present disclosure includes a first conversion circuitry configured to perform two-phase to three-phase conversion for a positive sequence d-axis current command value and a positive sequence q-axis current command value and outputs positive sequence current command values of three phases; a second conversion circuitry configured to perform the two-phase to three-phase conversion for a negative sequence d-axis current command value and a negative sequence q-axis current command value and outputs negative sequence current command values of the three phases; an addition circuitry configured to add the positive sequence current command values of the three phases and the negative sequence current command values of the three phases and outputs current command values of the three phases; an inverter control circuitry configured to control an inverter based on the current command values of the three phases; and an amplitude correction circuitry, wherein the amplitude correction circuitry is configured to calculate amplitude values of the three phases from the positive sequence d-axis current command value, the positive sequence q-axis current command value, the negative sequence d-axis current command value, and the negative sequence q-axis current command value, and perform correction such that amplitudes of the current command values of the three phases do not exceed a specified value in a case where a maximum amplitude value among the amplitude values of the three phases exceeds the specified value which is defined in advance.

A control method for a power conversion device according to the present disclosure includes performing two-phase to three-phase conversion for a positive sequence d-axis current command value and a positive sequence q-axis current command value to output positive sequence current command values of three phases; performing the two-phase to three-phase conversion for a negative sequence d-axis current command value and a negative sequence q-axis current command value to output negative sequence current command values of the three phases; adding the positive sequence current command values of the three phases and the negative sequence current command values of the three phases to output current command values of the three phases; controlling an inverter based on the current command values of the three phases; calculating amplitude values of the three phases from the positive sequence d-axis current command value, the positive sequence q-axis current command value, the negative sequence d-axis current command value, and the negative sequence q-axis current command value; and performing correction such that amplitudes of the current command values of the three phases do not exceed a specified value in a case where a maximum amplitude value among the amplitude values of the three phases exceeds the specified value which is defined in advance.

A program according to the present disclosure is executed by a processor of a control device, the control device controlling a power conversion device, and is configured to cause the processor to execute: performing two-phase to three-phase conversion for a positive sequence d-axis current command value and a positive sequence q-axis current command value to output positive sequence current command values of three phases; performing the two-phase to three-phase conversion for a negative sequence d-axis current command value and a negative sequence q-axis current command value to output negative sequence current command values of the three phases; adding the positive sequence current command values of the three phases and the negative sequence current command values of the three phases to output current command values of the three phases; controlling an inverter based on the current command values of the three phases; calculating amplitude values of the three phases from the positive sequence d-axis current command value, the positive sequence q-axis current command value, the negative sequence d-axis current command value, and the negative sequence q-axis current command value; and performing correction such that amplitudes of the current command values of the three phases do not exceed a specified value in a case where a maximum amplitude value among the amplitude values of the three phases exceeds the specified value which is defined in advance.

### Advantageous Effects of the Invention

In a control device, a power conversion device, a control method for a power conversion device and a program according to the present disclosure, correction is performed such that amplitudes of current command values of three phases do not exceed a specified value. Consequently, the amplitude of the current command value can be restricted to an arbitrary value.

### BRIEF DESCRIPTION OF DRAWINGS

FIG. 1 is a diagram for explaining a configuration of a power conversion device according to a first embodiment.

FIG. 2 is a diagram for explaining a configuration of the control device according to the first embodiment.

FIG. 3 is a flowchart illustrating the correction method for the amplitudes of the current command values of the three phases, according to the first embodiment.

FIG. 4 is a diagram for explaining a configuration of a control device according to a comparative example.

FIG. 5 is a diagram illustrating a hardware configuration example of a processing circuit provided in the control device according to the first embodiment.

FIG. 6 is a diagram for explaining a configuration of a control device according to a second embodiment.

FIG. 7 is a diagram for explaining a configuration of a control device according to a third embodiment.

FIG. 8 is a diagram for explaining a configuration of a control device according to a fourth embodiment.

### DESCRIPTION OF EMBODIMENT

A control device, a power conversion device, a control method for a power conversion device and a program according to each embodiment will be described with reference to the drawings. Identical or corresponding constitutional elements are given the same reference numerals, and the repeated description of such constitutional elements may be omitted.

### First Embodiment

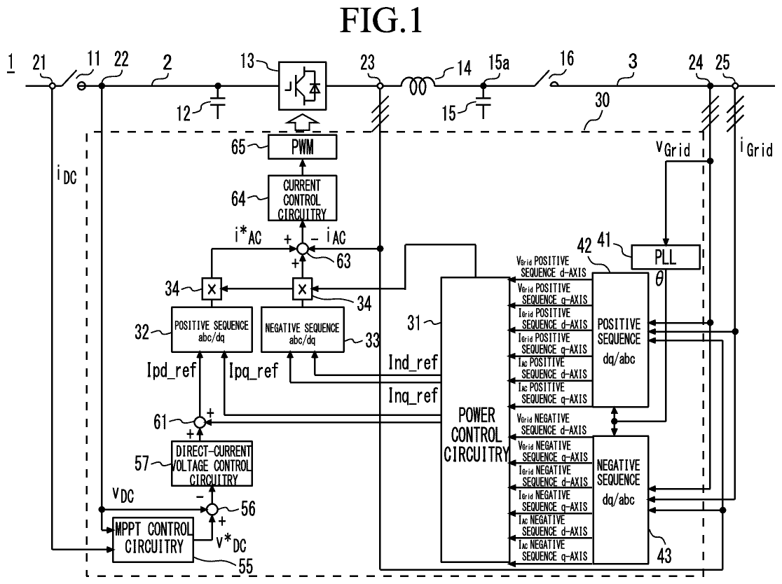

FIG. 1 is a diagram for explaining a configuration of a power conversion device 1 according to a first embodiment. In the power conversion device 1, an input terminal on a left side in FIG. 1 is connected with a direct-current power source which is not illustrated. Further, in the power conversion device 1, an output terminal on a right side in FIG. 1 is connected with an alternating-current power system which is not illustrated. The power conversion device 1 converts a direct-current power supplied from the direct-current power source to an alternating-current power and outputs the alternating-current power resulting from the conversion to the alternating-current power system. The power conversion device 1 in the present embodiment is a power conversion device (PV-PCS: photovoltaics-power conditioning system) for solar power generation (PV: photovoltaics), for example. In this case, the direct-current power source is a solar panel, for example. Types of direct-current power sources and purposes of use of the power conversion device 1 are not limited.

The power conversion device 1 has a direct-current switch 11, a direct-current capacitor 12, an inverter 13, an alternating-current reactor 14, an alternating-current capacitor 15, and an alternating-current switch 16. Further, the power conversion device 1 has a first current sensor 21, a first voltage sensor 22, a second current sensor 23, a second voltage sensor 24, a third current sensor 25, and a control device 30. Note that in FIG. 1, wiring for the control device 30 is not illustrated, but each element of the power conversion device 1 and the control device 30 are electrically connected together.

A direct-current busbar 2 connects the direct-current power source with a direct-current terminal of the inverter 13. The direct-current busbar 2 supplies the direct-current power to the inverter 13. On the direct-current busbar 2, for example, in order from the direct-current power source toward the direct-current terminal of the inverter 13, the first current sensor 21, the direct-current switch 11, the first voltage sensor 22, and the direct-current capacitor 12 are arranged.

An alternating-current circuit 3 connects an alternating-current terminal of the inverter 13 with the alternating-current power system. The alternating-current circuit 3 is a three-phase three-wire type three-phase alternating-current circuit, for example. In the three-phase three-wire type three-phase alternating-current circuit, three-phase alternating-current power in which three systems of single-phase alternating currents are combined together, the three systems having their phases of current or voltage being shifted from each other, is supplied by using three electric wires or cables. The alternating-current circuit 3 supplies the alternating-current power resulting from conversion by the inverter 13 to the alternating-current power system side. On the alternating-current circuit 3, for example, in order from the alternating-current terminal of the inverter 13 toward the alternating-current power system, the second current sensor 23, the alternating-current reactor 14, the alternating-current capacitor 15, the alternating-current switch 16, the second voltage sensor 24, and the third current sensor 25 are arranged.

The alternating-current power system is connected with the alternating-current terminal of the inverter 13 via the alternating-current circuit 3. The alternating-current power system is connected with a transformer which is not illustrated. The alternating-current power system is a system which integrates power generation, power conversion, power transmission, and power distribution for supplying alternating-current power, whose voltage is transformed by the transformer, to power receiving equipment, for example. The alternating-current power system is connected with an unspecified load, for example.

The direct-current switch 11 is a direct-current circuit breaker and is provided between the first current sensor 21 and the first voltage sensor 22 on the direct-current busbar 2. The direct-current switch 11 connects or cuts off the direct-current busbar 2 between the direct-current power source and the inverter 13 in accordance with a turning-on instruction or an opening instruction from the control device 30, an operator who is not illustrated, or the like. When the direct-current switch 11 is opened, the direct-current power to be supplied from the direct-current power source to the inverter 13 is cut off.

The direct-current capacitor 12 is provided between the first voltage sensor 22 and the direct-current terminal of the inverter 13 on the direct-current busbar 2. The direct-current capacitor 12 is a smoothing capacitor that smooths a direct-current voltage which is output from the direct-current power source. A voltage of the direct-current capacitor 12 rises by being charged by the direct-current power when the direct-current switch 11 is turned on and lowers by being discharged by a discharge circuit, a discharge resistance, or the like, which is not illustrated, when the direct-current switch 11 is opened.

The direct-current terminal of the inverter 13 is connected with the direct-current capacitor 12 and the direct-current switch 11 via the direct-current busbar 2, and the alternating-current terminal of the inverter 13 is connected with the alternating-current reactor 14. The inverter 13 is constructed with plural switching elements such as IGBTs (insulated gate bipolar transistors), for example. The inverter 13 is controlled by a pulse width modulation signal as a gate driving signal of the switching element, which is generated by a PWM (pulse width modulation) control circuitry 65 described later, for example.

The inverter 13 obtains the direct-current power, which is supplied from the direct-current power source, from one terminal side, converts the obtained direct-current power to the alternating-current power in accordance with control by the pulse width modulation signal, outputs the alternating-current power from the other terminal side as the output terminal, and thereby supplies the alternating-current power to the alternating-current power system side. Note that in the following, the pulse width modulation signal will also be referred to as “PWM signal”.

The alternating-current reactor 14 is connected in series with the alternating-current terminal of the inverter 13. The alternating-current reactor 14 configures an LC filter circuit, together with the alternating-current capacitor 15 which is connected in an L shape via a branch point 15a, for example. The LC filter circuit can reduce ripple which occurs when the switching element of the inverter 13 is switched.

The alternating-current capacitor 15 is an electronic component which accumulates and emits an electric charge and is connected with the alternating-current reactor 14 in an L shape via the branch point 15a. The alternating-current capacitor 15 and the alternating-current reactor 14 together configure the filter circuit, and a harmonic current can thereby be inhibited from flowing out to the alternating-current power system side.

The alternating-current switch 16 is an alternating-current circuit breaker and is provided in series between the alternating-current capacitor 15 and the alternating-current power system. The alternating-current switch 16 connects or cuts off the alternating-current circuit 3 between the inverter 13 and the alternating-current power system in accordance with a turning-on instruction or an opening instruction from the control device 30, the operator who is not illustrated, or the like, for example. When the alternating-current switch 16 is opened, the alternating-current power to be supplied from the inverter 13 to the alternating-current power system is cut off.

The first current sensor 21 is a known direct-current ammeter or direct current sensor, for example. The first current sensor 21 is arranged between the direct-current power source and the direct-current switch 11 and detects a value of a direct current i_{DC} which flows from the direct-current power source. Note that a position where the first current sensor 21 is arranged is not limited to the position illustrated in FIG. 1 but may be a position where the value of the direct current i_{DC} is detectable. The direct current i_{DC} detected by the first current sensor 21 is obtained by the control device 30.

The first voltage sensor 22 is a known direct-current voltmeter or direct-current voltage sensor, for example. The first voltage sensor 22 is arranged between the direct-current switch 11 and the direct-current capacitor 12 and detects a value of a direct-current voltage v_{DC} of the direct-current capacitor 12. Note that a position where the first voltage sensor 22 is arranged is not limited to the position illustrated in FIG. 1 but may be a position where the value of the direct-current voltage v_{DC} is detectable. The direct-current voltage v_{DC} detected by the first voltage sensor 22 is obtained by the control device 30.

The second current sensor 23 is a known alternating-current ammeter or alternating current sensor, for example. The second current sensor 23 is arranged between the inverter 13 and the alternating-current reactor 14 and detects a value of an inverter output current i_{AC} which is an output current of the inverter 13 and is also a three-phase alternating current. Note that a position where the second current sensor 23 is arranged is not limited to the position illustrated in FIG. 1 but may be a position where the value of the inverter output current i_{AC} is detectable. The inverter output current i_{AC} detected by the second current sensor 23 is obtained by the control device 30.

The second voltage sensor 24 is a known alternating-current voltmeter or alternating-current voltage sensor, for example. The second voltage sensor 24 is arranged between the alternating-current switch 16 and the alternating-current power system and detects a value of a system voltage v_{Grid} as a three-phase alternating-current voltage in the alternating-current power system. Note that a position where the second voltage sensor 24 is arranged is not limited to the position illustrated in FIG. 1 but may be a position where the value of the system voltage v_{Grid} is detectable. The system voltage v_{Grid} detected by the second voltage sensor 24 is obtained by the control device 30.

The third current sensor 25 is a known alternating-current ammeter or alternating current sensor, for example. The third current sensor 25 is arranged between the alternating-current switch 16 and the alternating-current power system and detects a value of a system current i_{Grid} as the three-phase alternating current which flows in the alternating-current power system. Note that a position where the third current sensor 25 is arranged is not limited to the position illustrated in FIG. 1 but may be a position where the value of the system current i_{Grid} is detectable. The system current i_{Grid} detected by the third current sensor 25 is obtained by the control device 30.

The control device 30 controls the power conversion device 1. The control device 30 is provided in an internal portion or an external portion of the power conversion device 1, for example, and is connected with each configuration, such as the inverter 13, of the power conversion device 1 in a wired or wireless manner. Note that the control device 30 may be realized as a function of an inverter control circuit which is not illustrated. The control device 30 may operate in accordance with an instruction from a host device which is not illustrated or an instruction from the operator via a manipulation circuitry which is not illustrated, for example. Note that the host device comprehensively monitors and controls plural power conversion devices 1 and is connected with each of the power conversion devices 1 in a wired or wireless manner, for example.

The control device 30 has configurations or functions of a PLL (phase locked loop) control circuitry 41, a conversion circuitry 42, a conversion circuitry 43, and a power control circuitry 31. Further, the control device 30 has configurations or functions of an MPPT (maximum power point tracking) control circuitry 55, a subtraction circuitry 56, and a direct-current voltage control circuitry 57. In addition, the control device 30 has configurations or functions of an addition circuitry 61, a conversion circuitry 32, a conversion circuitry 33, integration circuitries 34, a subtraction circuitry 63, a current control circuitry 64, and the PWM control circuitry 65.

The PLL control circuitry 41 is connected with the second voltage sensor 24 and the conversion circuitries 42 and 43. The PLL control circuitry 41 obtains information about the system voltage v_{Grid}. The PLL control circuitry 41 performs PLL control based on the system voltage v_{Grid} and outputs information about a reference phase θ, which is synchronized with the system voltage v_{Grid}, to the conversion circuitries 42 and 43.

The conversion circuitry 42 is connected with the second voltage sensor 24, the PLL control circuitry 41, and the power control circuitry 31. The conversion circuitry 42 obtains the information about the system voltage v_{Grid} and the information about the reference phase θ which is output from the PLL control circuitry 41. The conversion circuitry 42 performs three-phase to two-phase conversion based on the obtained reference phase θ and thereby converts the system voltage v_{Grid} to a value of a positive sequence d-axis voltage and a value of a positive sequence q-axis voltage. The three-phase to two-phase conversion will also be referred to as dq conversion. Note that the reference phase θ for the dq conversion has a q-axis voltage component of zero, for example. The conversion circuitry 42 outputs information about the value of the positive sequence d-axis voltage and information about the value of the positive sequence q-axis voltage to the power control circuitry 31.

The conversion circuitry 42 is further connected with the second current sensor 23, the third current sensor 25, and the power control circuitry 31. The conversion circuitry 42 obtains information about the inverter output current i_{AC}, information about the system current i_{Grid}, and the information about the reference phase θ which is output from the PLL control circuitry 41. The conversion circuitry 42 performs the three-phase to two-phase conversion based on the obtained reference phase θ and converts the inverter output current i_{AC} and the system current i_{Grid} to a value of a positive sequence d-axis current and a value of a positive sequence q-axis current. Note that the reference phase θ for the dq conversion has a q-axis voltage component of zero, for example. The conversion circuitry 42 outputs information about the value of the positive sequence d-axis current and information about the value of the positive sequence q-axis current to the power control circuitry 31. The value of the positive sequence d-axis current of the inverter output current corresponds to a positive sequence d-axis current measurement value Ipd_fbk which will be described later, and the value of the positive sequence q-axis current corresponds to a positive sequence q-axis current measurement value Ipq_fbk which will be described later.

The conversion circuitry 43 is connected with the second voltage sensor 24, the PLL control circuitry 41, and the power control circuitry 31. The conversion circuitry 43 obtains the information about the system voltage v_{Grid} and the information about the reference phase θ which is output from the PLL control circuitry 41. The conversion circuitry 43 performs the three-phase to two-phase conversion based on the obtained reference phase θ and thereby converts the system voltage v_{Grid} to a value of a negative sequence d-axis voltage and a voltage of a negative sequence q-axis voltage. The conversion circuitry 43 outputs information about the value of the negative sequence d-axis voltage and information about the value of the negative sequence q-axis voltage to the power control circuitry 31.

The conversion circuitry 43 is further connected with the second current sensor 23, the third current sensor 25, and the power control circuitry 31. The conversion circuitry 43 obtains the information about the inverter output current i_{AC}, the information about the system current i_{Grid}, and the information about the reference phase θ which is output from the PLL control circuitry 41. The conversion circuitry 43 performs the three-phase to two-phase conversion based on the obtained reference phase θ and converts the inverter output current i_{AC} and the system current i_{Grid} to a value of a negative sequence d-axis current and a value of a negative sequence q-axis current. The conversion circuitry 43 outputs information about the value of the negative sequence d-axis current and information about the value of the negative sequence q-axis current to the power control circuitry 31. The value of the negative sequence d-axis current of the inverter output current corresponds to a negative sequence d-axis current measurement value Ind_fbk which will be described later, and the value of the negative sequence q-axis current corresponds to a negative sequence q-axis current measurement value Inq_fbk which will be described later.

The power control circuitry 31 is connected with the conversion circuitries 42 and 43, the addition circuitry 61, and the conversion circuitries 32 and 33. The power control circuitry 31 obtains the information about the values of the positive sequence d-axis voltage, the positive sequence q-axis voltage, the positive sequence d-axis current, and the positive sequence q-axis current from the conversion circuitry 42. In addition, the power control circuitry 31 obtains the information about the values of the negative sequence d-axis voltage, the negative sequence q-axis voltage, the negative sequence d-axis current, and the negative sequence q-axis current from the conversion circuitry 43. Based on the obtained information, the power control circuitry 31 may obtain values of a positive sequence d-axis current command value, a positive sequence q-axis current command value Ipq_ref, a negative sequence d-axis current command value Ind_ref, and a negative sequence q-axis current command value Inq_ref, which will be described later.

The MPPT control circuitry 55 is connected with the first current sensor 21, the first voltage sensor 22, and the subtraction circuitry 56. The MPPT control circuitry 55 obtains information about the direct current i_{DC} as a detection value of the first current sensor 21 and information about the direct-current voltage v_{DC} as a detection value of the first voltage sensor 22. Based on the obtained information about the direct current i_{DC} and the obtained information about the direct-current voltage v_{DC}, the MPPT control circuitry 55 performs MPPT control based on known hill climbing, for example, and thereby calculates a direct-current voltage command value v*_{DC}. A range of a limiter of the MPPT control by the MPPT control circuitry 55 is defined for each device, for example.

The subtraction circuitry 56 is connected with the first voltage sensor 22 and the MPPT control circuitry 55. The subtraction circuitry 56 obtains the information about the direct-current voltage v_{DC} as the detection value of the first voltage sensor 22 and information about the direct-current voltage command value v*_{DC} which is output from the MPPT control circuitry 55. The subtraction circuitry 56 calculates the value resulting from the subtraction of the direct-current voltage v_{DC} from the direct-current voltage command value v*_{DC}. The subtraction circuitry 56 outputs information about the calculated value to the direct-current voltage control circuitry 57.

The direct-current voltage control circuitry 57 is connected with the subtraction circuitry 56 and the addition circuitry 61. The direct-current voltage control circuitry 57 obtains information about the value resulting from the subtraction of the direct-current voltage v_{DC} from the direct-current voltage command value v*_{DC}, the information being output from the subtraction circuitry 56. The direct-current voltage control circuitry 57 controls the obtained information and thereby calculates the positive sequence d-axis current command value. The direct-current voltage control circuitry 57 outputs information about the calculated positive sequence d-axis current command value to the addition circuitry 61.

The addition circuitry 61 is connected with the power control circuitry 31, the direct-current voltage control circuitry 57, and the conversion circuitry 32. The addition circuitry 61 obtains information about a d-axis current command value which is output from the power control circuitry 31 and information about a d-axis current command value which is output from the direct-current voltage control circuitry 57. The addition circuitry 61 calculates the value resulting from the addition of the obtained d-axis current command values. The addition circuitry 61 sets information about the value resulting from the addition as a positive sequence d-axis current command value Ipd_ref and outputs that to the conversion circuitry 32.

Next, a description will be made, by using FIGS. 1 to 3, about a method for calculating current command values of three phases of a U phase, a V phase, and a W phase from the positive sequence d-axis current command value Ipd_ref, the positive sequence q-axis current command value Ipq_ref, the negative sequence d-axis current command value Ind_ref, and the negative sequence q-axis current command value Inq_ref.

As illustrated in FIG. 1, the conversion circuitry 32 is connected with the power control circuitry 31, the addition circuitry 61, and the integration circuitry 34. The conversion circuitry 32 obtains information about the positive sequence q-axis current command value Ipq_ref which is output from the power control circuitry 31 and information about the positive sequence d-axis current command value Ipd_ref which is output from the addition circuitry 61. The conversion circuitry 32 performs two-phase to three-phase conversion for the positive sequence d-axis current command value Ipd_ref and the positive sequence q-axis current command value Ipq_ref and outputs positive sequence current command values of the three phases.

The conversion circuitry 33 is connected with the power control circuitry 31 and the integration circuitry 34. The conversion circuitry 33 obtains information about the negative sequence d-axis current command value Ind_ref and information about the negative sequence q-axis current command value Inq_ref, which are output from the power control circuitry 31. The conversion circuitry 33 performs the two-phase to three-phase conversion for the negative sequence d-axis current command value Ind_ref and the negative sequence q-axis current command value Inq_ref and outputs negative sequence current command values of the three phases.

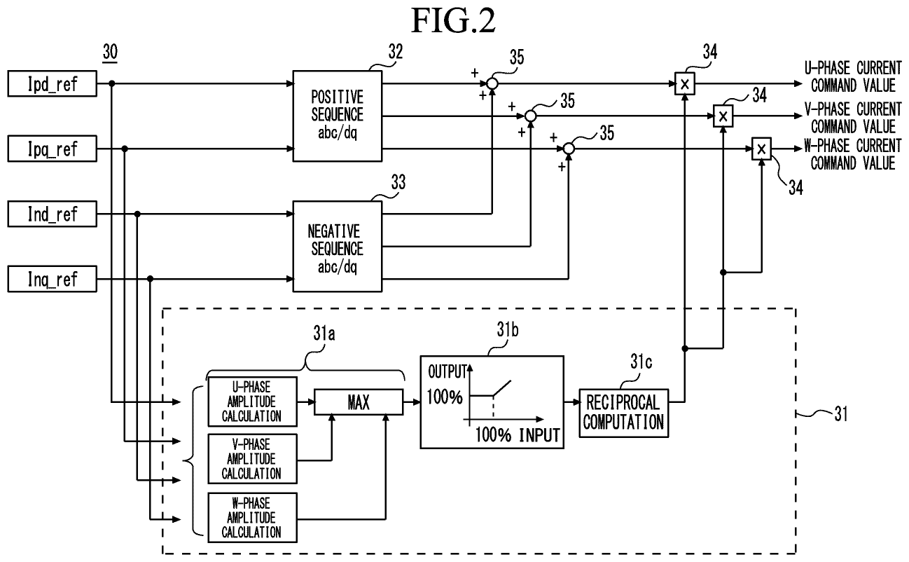

FIG. 2 is a diagram for explaining a configuration of the control device 30 according to the first embodiment. FIG. 2 illustrates principal components of the control device 30 but does not illustrate a part of configurations. As illustrated in FIG. 2, addition circuitries 35 are provided on output sides of the conversion circuitries 32 and 33. The addition circuitries 35 add the positive sequence current command values of the three phases and the negative sequence current command values of the three phases and output current command values of the three phases. The current command values of the three phases are a U-phase current command value, a V-phase current command value, and a W-phase current command value. Integration circuitries 34 are provided on output sides of the addition circuitries 35. The current command values of the three phases are input to the integration circuitries 34.

Next, a description will be made about a correction method for amplitudes of the current command values of the three phases. The power control circuitry 31 and the integration circuitries 34 correspond to an amplitude correction circuitry. The amplitude correction circuitry calculates amplitude values of the three phases of the U phase, the V phase, and the W phase from the positive sequence d-axis current command value Ipd_ref, the positive sequence q-axis current command value Ipq_ref, the negative sequence d-axis current command value Ind_ref, and the negative sequence q-axis current command value Inq_ref. In a case where the maximum amplitude value among the calculated amplitude values of the three phases exceeds a specified value which is defined in advance, the amplitude correction circuitry performs correction such that the amplitudes of the current command values of the three phases do not exceed the specified value. Specifically, the amplitude correction circuitry multiplies the current command values of the three phases, which are output from the addition circuitries 35, by the reciprocal of the maximum amplitude value among the amplitude values of the three phases and thereby performs correction.

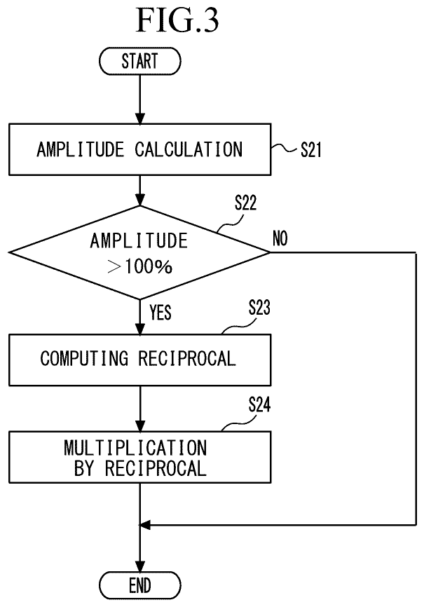

FIG. 3 is a flowchart illustrating the correction method for the amplitudes of the current command values of the three phases, according to the first embodiment. An amplitude calculation circuitry 31a of the power control circuitry 31 calculates the amplitude values of the three phases from the positive sequence d-axis current command value Ipd_ref, the positive sequence q-axis current command value Ipq_ref, the negative sequence d-axis current command value Ind_ref, and the negative sequence q-axis current command value Inq_ref (step 21). Specifically, the amplitude of each of the U phase, the V phase, and the W phase is calculated. The amplitude calculation circuitry 31a further extracts the maximum amplitude value among the calculated amplitude values of the three phases. Next, a comparison circuitry 31b of the power control circuitry 31 compares the maximum amplitude value with the specified value (step 22). The specified value is a rated value of the power conversion device 1, for example. In the example in FIG. 2, the comparison circuitry 31b sets the rated value to 100% and thereby determines whether or not the maximum amplitude value exceeds 100%. Note that the specified value is not limited to the rated value but may be set to an arbitrary value.

In a case where the maximum amplitude value is the specified value or less, the control is finished. In a case where the maximum amplitude value is larger than the specified value, a reciprocal computation circuitry 31c of the power control circuitry 31 computes the reciprocal of the maximum amplitude value and outputs that to the integration circuitries 34 (step 23). The integration circuitries 34 output the respective results of the multiplication of the current command values of the three phases by the reciprocal of the maximum amplitude value as the corrected current command values of the three phases (step 24). Consequently, the correction of the amplitudes of the current command values of the three phases is completed.

Next, a description will be made in detail about a method for calculating the amplitude values of the three phases. The current command values of the three phases can be expressed by an expression 1 by using an inverse conversion expression of the two-phase to three-phase conversion.

$$[ \begin{matrix}\begin{matrix}{I}_{u} \\ {I}_{v}\end{matrix} \\ {I}_{w}\end{matrix} ] = [ \begin{matrix}\begin{matrix}{I}_{pu} \\ {I}_{pv}\end{matrix} \\ {I}_{pw}\end{matrix} ] + [ \begin{matrix}\begin{matrix}{I}_{nu} \\ {I}_{nv}\end{matrix} \\ {I}_{nw}\end{matrix} ] = \sqrt{\frac{2}{3}} [ \begin{matrix}sin θ & cos θ \\ sin ( θ - \frac{2 π}{3} ) & cos ( θ - \frac{2 π}{3} ) \\ sin ( θ + \frac{2 π}{3} ) & cos ( θ + \frac{2 π}{3} )\end{matrix} ] [ \begin{matrix}{i}_{pd} \\ {i}_{pq}\end{matrix} ] + \sqrt{\frac{2}{3}} [ \begin{matrix}sin ( - θ ) & cos ( - θ ) \\ sin ( - θ - \frac{2 π}{3} ) & cos ( - θ - \frac{2 π}{3} ) \\ sin ( - θ + \frac{2 π}{3} ) & cos ( - θ + \frac{2 π}{3} )\end{matrix} ] [ \begin{matrix}{i}_{nd} \\ {i}_{nq}\end{matrix} ] \qquad [ Math . 1 ]$$

Here, Iu, Iv, and Iw denote the current command values of the three phases, Ipu, Ipv, and Ipw denote the positive sequence current command values of the three phases, and Inu, Inv, and Inw denote the negative sequence current command values of the three phases. Further, ipd denotes a positive sequence d-axis current command value, ipq denotes a positive sequence q-axis current command value, ind denotes a negative sequence d-axis current command value, and inq denotes a negative sequence q-axis current command value. By converting the expression 1, the following expression 2 can be obtained.

$$[ \begin{matrix}\begin{matrix}{I}_{u} \\ {I}_{v}\end{matrix} \\ {I}_{w}\end{matrix} ] = \sqrt{\frac{2}{3}} [ \begin{matrix}\begin{matrix}\sqrt{{( {i}_{pd} - {i}_{nd} )}^{2} + {( {i}_{pq} + {i}_{nq} )}^{2}} \\ \sqrt{\begin{matrix}{( - \frac{1}{2} {i}_{pd} + \frac{\sqrt{3}}{2} {i}_{pq} + \frac{1}{2} {i}_{nd} - \frac{\sqrt{3}}{2} {i}_{nq} )}^{2} + \\ {( - \frac{\sqrt{3}}{2} {i}_{pd} - \frac{1}{2} {i}_{pq} - \frac{\sqrt{3}}{2} {i}_{nd} - \frac{1}{2} {i}_{nq} )}^{2}\end{matrix}}\end{matrix} \\ \sqrt{\begin{matrix}{( - \frac{1}{2} {i}_{pd} - \frac{\sqrt{3}}{2} {i}_{pq} + \frac{1}{2} {i}_{nd} + \frac{\sqrt{3}}{2} {i}_{nq} )}^{2} + \\ {( \frac{\sqrt{3}}{2} {i}_{pd} - \frac{1}{2} {i}_{pq} + \frac{\sqrt{3}}{2} {i}_{nd} - \frac{1}{2} {i}_{nq} )}^{2}\end{matrix}}\end{matrix} ] \qquad [ Math . 2 ]$$

By using the expression 2, the amplitude values of the three phases of the U phase, the V phase, and the W phase can be calculated from the positive sequence d-axis current command value ipd, the positive sequence q-axis current command value ipq, the negative sequence d-axis current command value ind, and the negative sequence q-axis current command value inq.

Note that the number and positions of integration circuitries 34 are different between FIG. 1 and FIG. 2. In FIG. 1, the integration circuitries 34 are separately provided on the output sides of the conversion circuitries 32 and 33. As described above, the amplitude correction circuitry may perform correction by multiplying the positive sequence current command values of the three phases, which are output from the conversion circuitry 32, and the negative sequence current command values of the three phases, which are output from the conversion circuitry 33, by the reciprocal of the maximum amplitude value. After the multiplication by the reciprocal, the corrected positive sequence current command values of the three phases and the corrected negative sequence current command values of the three phases are added together in the subtraction circuitry 63. It is also possible, by this method, to perform correction of the amplitudes of the current command values of the three phases, the correction being similar to that in the configuration in FIG. 2.

Next, a description will be made, by using FIG. 1, about control of the inverter 13 by the corrected current command values of the three phases. The subtraction circuitry 63 is connected with the second current sensor 23 and the integration circuitries 34. The subtraction circuitry 63 obtains the information about the inverter output current i_{AC} as a detection value of the second current sensor 23 and information about corrected current command values i*_{AC} of the three phases. Note that as described above, to the subtraction circuitry 63, instead of the corrected current command values i*_{AC} of the three phases, the corrected positive sequence current command values of the three phases and the corrected negative sequence current command values of the three phases may be input. The subtraction circuitry 63 calculates the values resulting from the subtraction of the inverter output currents i_{AC} from the current command values i*_{AC} of the three phases. The subtraction circuitry 63 outputs information about the calculated values to the current control circuitry 64.

The current control circuitry 64 is connected with the subtraction circuitry 63 and the PWM control circuitry 65. The current control circuitry 64 obtains information about a value output from the subtraction circuitry 63. The current control circuitry 64 calculates a voltage command value by controlling the obtained information. The current control circuitry 64 outputs the calculated voltage command value to the PWM control circuitry 65.

The PWM control circuitry 65 is connected with the inverter 13 and the current control circuitry 64. The PWM control circuitry 65 obtains the voltage command value from the current control circuitry 64. The PWM control circuitry 65 performs PWM control based on the obtained voltage command value and thereby produces a gate signal as the PWM signal. The PWM control circuitry 65 outputs the produced gate signal to the inverter 13, controls the switching element of the inverter 13, and comprehensively controls an operation of the inverter 13. Note that the PWM control circuitry 65 is one example of an inverter control circuitry which controls the inverter 13 based on the current command values of the three phases.

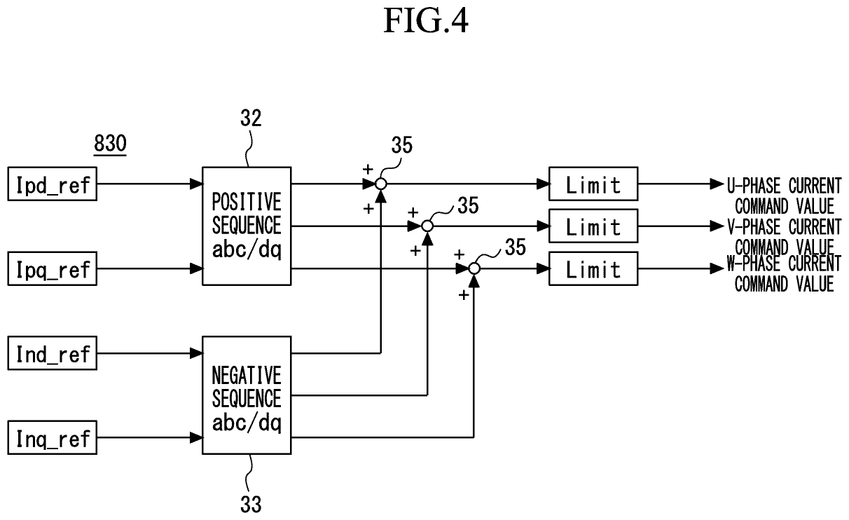

FIG. 4 is a diagram for explaining a configuration of a control device 830 according to a comparative example. The control device 830 according to the comparative example is different from the control device 30 of the present embodiment in the point that correction of the amplitudes is not performed. In this case, depending on a phase relationship of the current command values between a positive sequence and a negative sequence, the amplitudes of the current command values of the three phases, which result from summation, might become excessively large. In other words, because the amplitudes resulting from the summation of the positive sequence and the negative sequence are not taken into consideration in the comparative example, there is a possibility that a value which exceeds the rated value is output.

On the other hand, in the present embodiment, the amplitude values of the current command values of the three phases are computed from the positive sequence current command values and the negative sequence current command values. Further, in a case where the current of the phase which has the maximum amplitude value among the three phases exceeds the specified value, the current command values can be corrected such that the current of the phase which has the maximum amplitude value agrees with the specified value. Consequently, the amplitude of the current command value can be restricted to an arbitrary value. Further, because the power conversion device 1 of the present embodiment can use both of the positive sequence and the negative sequence, it is possible to apply the present embodiment to a system in which the negative sequence has to be output, for example.

In the present embodiment, the correction is performed such that the current of the phase which has the maximum amplitude value agrees with the specified value. This is not restrictive, and it is sufficient that the correction is performed based on the calculated amplitude values of the three phases such that the amplitudes of the current command values of the three phases do not exceed the specified value.

Further, in the present embodiment, a description is made about an example where the positive sequence d-axis current command value Ipd_ref, the positive sequence q-axis current command value Ipq_ref, the negative sequence d-axis current command value Ind_ref, and the negative sequence q-axis current command value Inq_ref are set based on measurement values. This is not restrictive, and the positive sequence d-axis current command value Ipd_ref, the positive sequence q-axis current command value Ipq_ref, the negative sequence d-axis current command value Ind_ref, and the negative sequence q-axis current command value Inq_ref may be retained in advance by the power control circuitry 31 or the control device 30. The positive sequence d-axis current command value Ipd_ref, the positive sequence q-axis current command value Ipq_ref, the negative sequence d-axis current command value Ind_ref, and the negative sequence q-axis current command value Inq_ref may be output by the power control circuitry 31 in response to a command from an external portion of the power conversion device 1.

Further, feedback control may be performed so as to cancel the difference between the positive sequence d-axis current command value Ipd_ref and the positive sequence d-axis current measurement value Ipd_fbk. A PI compensator can be used for the feedback control. In this case, the positive sequence d-axis current command value Ipd_ref illustrated in FIG. 2 may be a signal which is provided after the feedback control. Similarly, the positive sequence q-axis current command value Ipq_ref, the negative sequence d-axis current command value Ind_ref, and the negative sequence q-axis current command value Inq_ref may be signals which are provided after the feedback control.

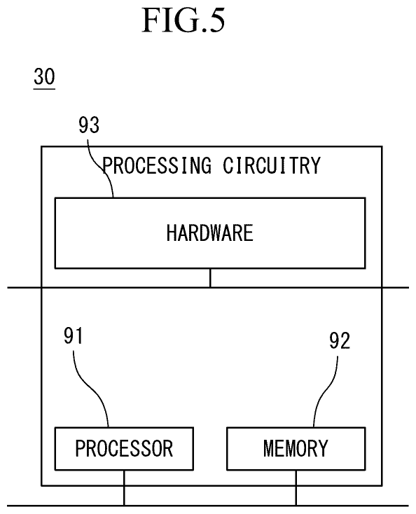

FIG. 5 is a diagram illustrating a hardware configuration example of a processing circuit provided in the control device 30 according to the first embodiment. Functions of the control device 30 can be realized by the processing circuit. As one form, the processing circuit includes at least one processor 91 and at least one memory 92. As another form, the processing circuit includes at least one piece of dedicated hardware 93.

In a case where the processing circuit includes the processor 91 and the memory 92, the functions are realized by software, firmware, or a combination of software and firmware. At least one of the software and the firmware is described as a program. At least one of the software and the firmware is stored in the memory 92. The processor 91 reads out and executes programs stored in the memory 92 and thereby realizes the functions. That is, the control device 30 is also realizable with a computer and programs, and the programs are capable of being stored in a storage medium and of being provided through a network.

In a case where the processing circuit includes the dedicated hardware 93, the processing circuit is a single circuit, a composite circuit, a processor formed as a program, or a combination of those, for example. The functions may be realized by such hardware 93. As for the functions provided in the control device 30, a part or all of those may be configured with the hardware 93, and a part or all of those may be configured as a program to be executed by the processor 91.

It can be considered that the program to be executed by the processor 91 is configured to cause the processor 91 to execute at least the following first to sixth processes. The first process is a process of performing the two-phase to three-phase conversion for the positive sequence d-axis current command value Ipd_ref and the positive sequence q-axis current command value Ipq_ref and of outputting the positive sequence current command values of the three phases. The second process is a process of performing the two-phase to three-phase conversion for the negative sequence d-axis current command value Ind_ref and the negative sequence q-axis current command value Inq_ref and of outputting the negative sequence current command values of the three phases. The third process is a process of adding the positive sequence current command values of the three phases and the negative sequence current command values of the three phases and of outputting the current command values of the three phases. The fourth process is a process of controlling the inverter based on the current command values of the three phases. The fifth process is a process of calculating the amplitude values of the three phases from the positive sequence d-axis current command value Ipd_ref, the positive sequence q-axis current command value Ipq_ref, the negative sequence d-axis current command value Ind_ref, and the negative sequence q-axis current command value Inq_ref. The sixth process is a process of performing the correction such that the amplitudes of the current command values of the three phases do not exceed the specified value in a case where the maximum amplitude value among the amplitude values of the three phases exceeds the specified value which is defined in advance.

The processor 91 may be a CPU (central processing unit), a RISC (reduced instruction set computer), a DSP (digital signal processor), an FPGA (field-programmable gate array), an ASIC (application specific integrated circuit), a PLD (programmable logic device), or another processing unit, for example. Further, the processor 91 may be a combination of two or more of those.

The memory 92 is a volatile or non-volatile storage medium such as an HDD (hard disk drive), an SSD (solid state drive), a DRAM (dynamic random-access memory), or a semiconductor memory. Further, the memory 92 may be a combination of two or more of those. The memory 92 is connected the units of the control device 30 such that inputs and outputs of various types of information are possible by a bus or the like which is not illustrated, for example. As for the memory 92, for example, programs necessary for operations of the units of the control device 30 are stored, and writing and reading of various types of information are performed by the units of the control device 30.

The memory 92 stores values obtained by each of the sensors or the like such as the first current sensor 21, for example. Further, the memory 92 stores the specified value, the rated value, the program for correcting the amplitudes, and so forth, which are described above, for example. Further, the memory 92 stores computation results by each of the units such as the power control circuitry 31, for example. Note that the memory 92 may be provided in an external portion of the control device 30 and connected with the control device 30 in a wired or wireless manner and may be an external storage medium or the like such as a memory card or a DVD (digital versatile disc), an online storage, or the like.

These modifications can be applied, as appropriate, to control devices, power conversion devices, control methods for a power conversion device and programs according to the following embodiments. Note that the control devices, the power conversion devices, the control methods for a power conversion device and the programs according to the following embodiments are similar to those of the first embodiment in many respects, and thus differences between the control devices, the power conversion devices, the control methods for a power conversion device and the programs according to the following embodiments and those of the first embodiment will be mainly described below.

### Second Embodiment

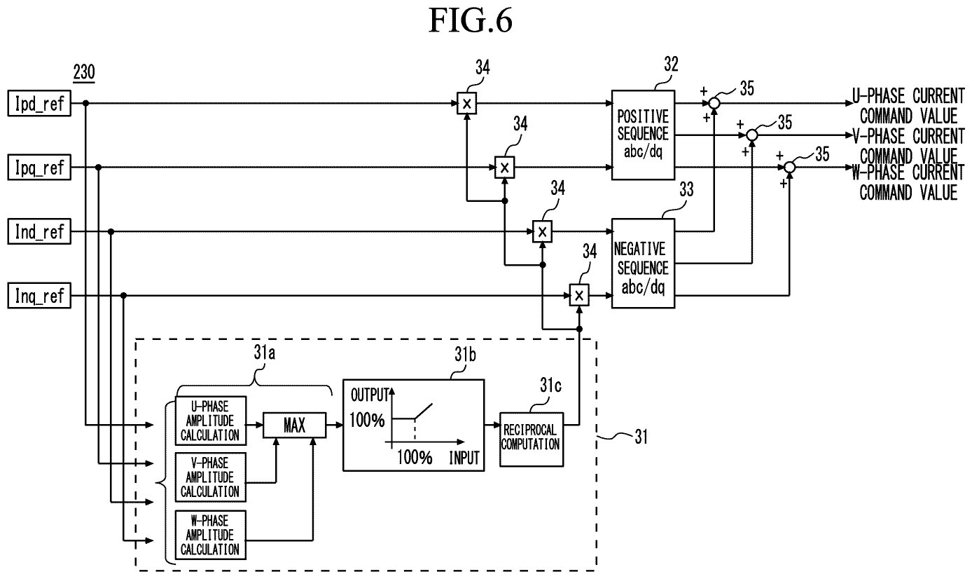

FIG. 6 is a diagram for explaining a configuration of a control device 230 according to a second embodiment. In the first embodiment, the correction of the amplitudes is carried out in rear stages of the conversion circuitries 32 and 33. On the other hand, the present embodiment is different from the first embodiment in the point that the correction of the amplitudes is carried out in front stages of the conversion circuitries 32 and 33. In other words, in the present embodiment, the integration circuitries 34 are provided on input sides of the conversion circuitries 32 and 33. Other configurations are similar to configurations of the first embodiment.

Similarly to the first embodiment, the power control circuitry 31 calculates the amplitude values of the three phases from the positive sequence d-axis current command value Ipd_ref, the positive sequence q-axis current command value Ipq_ref, the negative sequence d-axis current command value Ind_ref, and the negative sequence q-axis current command value Inq_ref (step 21). The amplitude calculation circuitry 31a further extracts the maximum amplitude value among the calculated amplitude values of the three phases. Next, the comparison circuitry 31b of the power control circuitry 31 compares the maximum amplitude value with the specified value (step 22). In a case where the maximum amplitude value is the specified value or less, the control is finished. In a case where the maximum amplitude value is larger than the specified value, the reciprocal computation circuitry 31c of the power control circuitry 31 computes the reciprocal of the maximum amplitude value and outputs that to the integration circuitries 34 (step 23).

The integration circuitries 34 output the respective results of the multiplication of the positive sequence d-axis current command value Ipd_ref and the positive sequence q-axis current command value Ipq_ref by the reciprocal of the maximum amplitude value to the conversion circuitry 32 (step 24). Further, the integration circuitries 34 output the respective results of the multiplication of the negative sequence d-axis current command value Ind_ref and the negative sequence q-axis current command value Inq_ref by the reciprocal of the maximum amplitude value to the conversion circuitry 33 (step 24).

The conversion circuitry 32 performs the two-phase to three-phase conversion for the corrected positive sequence d-axis current command value Ipd_ref and the corrected positive sequence q-axis current command value Ipq_ref and outputs the positive sequence current command values of the three phases. The conversion circuitry 33 performs the two-phase to three-phase conversion for the corrected negative sequence d-axis current command value Ind_ref and the corrected negative sequence q-axis current command value Inq_ref and outputs the negative sequence current command values of the three phases. The addition circuitries 35 add the positive sequence current command values of the three phases and the negative sequence current command values of the three phases and output the current command values of the three phases. Consequently, the correction of the amplitudes of the current command values of the three phases is completed.

The amplitude correction circuitry of the present embodiment performs the correction by multiplying the positive sequence d-axis current command value Ipd_ref, the positive sequence q-axis current command value Ipq_ref, the negative sequence d-axis current command value Ind_ref, and the negative sequence q-axis current command value Inq_ref by the reciprocal of the maximum amplitude value among the amplitude values of the three phases. In this case also, the correction of the amplitudes of the current command values of the three phases can be performed, and the amplitude of the current command value can thereby be restricted to an arbitrary value.

### Third Embodiment

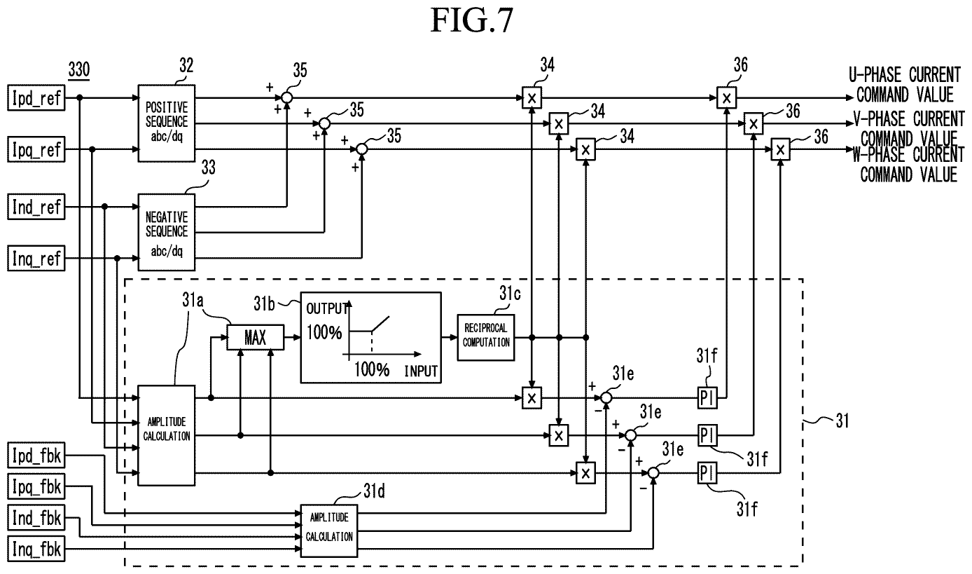

FIG. 7 is a diagram for explaining a configuration of a control device 330 according to a third embodiment. The control device 330 of the present embodiment further includes an amplitude calculation circuitry 31d, subtraction circuitries 31e, PI compensators 31f, and integration circuitries 36, compared to the control device 30 of the first embodiment. Other configurations are similar to configurations of the first embodiment.

The amplitude calculation circuitry 31d calculates feedback amplitude values as amplitude values of current measurement values of the three phases from the positive sequence d-axis current measurement value Ipd_fbk, the positive sequence q-axis current measurement value Ipq_fbk, the negative sequence d-axis current measurement value Ind_fbk, and the negative sequence q-axis current measurement value Inq_fbk. In this case, by using the above-described expression 2, the feedback amplitude values of the three phases of the U phase, the V phase, and the W phase can be calculated from a positive sequence d-axis current measurement value ipd, a positive sequence q-axis current measurement value ipq, a negative sequence d-axis current measurement value ind, and a negative sequence q-axis current measurement value inq.

To the subtraction circuitries 31e, the corrected amplitudes of the current command values of the three phases and the feedback amplitude values of the three phases are input. The corrected amplitudes of the current command values of the three phases have been corrected by the multiplication by the reciprocal of the maximum amplitude value by similar computation to that in the first embodiment. The PI compensators 31f output signals for further correcting the amplitudes of the current command values of the three phases so as to cancel the differences between the corrected amplitudes of the current command values of the three phases and the feedback amplitude values. In the integration circuitries 36, the corrected current command values of the three phases, which are output from the integration circuitries 34, are multiplied by the signals from the PI compensators 31f.

As described above, the amplitude correction circuitry of the present embodiment further corrects the amplitudes of the current command values of the three phases by the feedback control so as to cancel the differences between the amplitudes of the current command values of the three phases, which have been corrected by the integration circuitries 34, and the feedback amplitude values. In the present embodiment, in addition to effects of the first embodiment, control deviations can be canceled by the feedback control by the PI compensators 31f.

### Fourth Embodiment

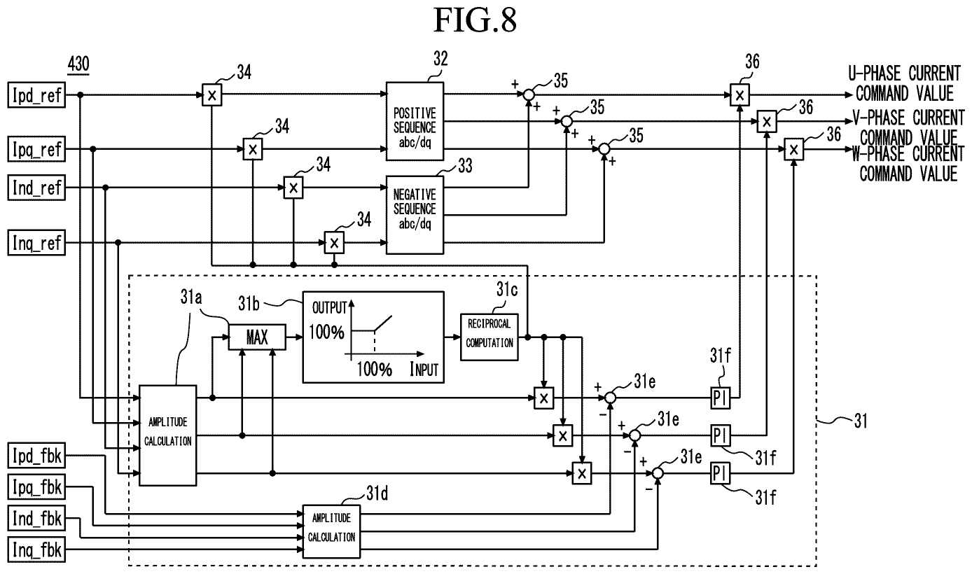

FIG. 8 is a diagram for explaining a configuration of a control device 430 according to a fourth embodiment. The control device 430 of the present embodiment further includes the amplitude calculation circuitry 31d, the subtraction circuitries 31e, the PI compensators 31f, and the integration circuitries 36, which are described in the third embodiment, compared to the control device 230 of the second embodiment. Other configurations are similar to configurations of the second embodiment.

Similarly to the third embodiment, the amplitude calculation circuitry 31d calculates the feedback amplitude values from the positive sequence d-axis current measurement value Ipd_fbk, the positive sequence q-axis current measurement value Ipq_fbk, the negative sequence d-axis current measurement value Ind_fbk, and the negative sequence q-axis current measurement value Inq_fbk. The feedback amplitude values are the amplitude values of the current measurement values of the three phases.

To the subtraction circuitries 31e, the corrected amplitudes of the current command values of the three phases and the feedback amplitude values of the three phases are input. The corrected amplitudes of the current command values of the three phases have been corrected by the multiplication by the reciprocal of the maximum amplitude value by similar computation to that in the second embodiment. The PI compensators 31f output signals for further correcting the amplitudes of the current command values of the three phases so as to cancel the differences between the corrected amplitudes of the current command values of the three phases and the feedback amplitude values. In the integration circuitries 36, the corrected current command values of the three phases, which are output from the addition circuitries 35, are multiplied by the signals from the PI compensators 31f.

As described above, in the present embodiment, the amplitudes of the current command values of the three phases are further corrected by the feedback control so as to cancel the differences between the amplitudes of the current command values of the three phases, which have been corrected by the multiplication by the reciprocal of the amplitude value, and the feedback amplitude values. In the present embodiment also, the control deviations can be canceled by the feedback control by the PI compensators 31f.

Note that the technical features described in the above embodiments may be combined as appropriate.

### REFERENCE SIGNS LIST

1 power conversion device, 2 direct-current busbar, 3 alternating-current circuit, 11 direct-current switch, 12 direct-current capacitor, 13 inverter, 14 alternating-current reactor, 15 alternating-current capacitor, 15a branch point, 16 alternating-current switch, 21 first current sensor, 22 first voltage sensor, 23 second current sensor, 24 second voltage sensor, 25 third current sensor, 30 control device, 31 power control circuitry, 31a amplitude calculation circuitry, 31b comparison circuitry, 31c reciprocal computation circuitry, 31d amplitude calculation circuitry, 31e subtraction circuitry, 31f PI compensator, 32 conversion circuitry, 33 conversion circuitry, 34 integration circuitry, 35 addition circuitry, 36 integration circuitry, 41 PLL control circuitry, 42 conversion circuitry, 43 conversion circuitry, 55 MPPT control circuitry, 56 subtraction circuitry, 57 direct-current voltage control circuitry, 61 addition circuitry, 63 subtraction circuitry, 64 current control circuitry, 65 PWM control circuitry, 91 processor, 92 memory, 93 hardware, 230 control device, 330 control device, 430 control device, 830 control device

1. A control device comprising:
a first conversion circuitry configured to perform two-phase to three-phase conversion for a positive sequence d-axis current command value and a positive sequence q-axis current command value and outputs positive sequence current command values of three phases;
a second conversion circuitry configured to perform the two-phase to three-phase conversion for a negative sequence d-axis current command value and a negative sequence q-axis current command value and outputs negative sequence current command values of the three phases;
an addition circuitry configured to add the positive sequence current command values of the three phases and the negative sequence current command values of the three phases and outputs current command values of the three phases;
an inverter control circuitry configured to control an inverter based on the current command values of the three phases; and
an amplitude correction circuitry, wherein
the amplitude correction circuitry is configured to
calculate amplitude values of the three phases from the positive sequence d-axis current command value, the positive sequence q-axis current command value, the negative sequence d-axis current command value, and the negative sequence q-axis current command value, and
perform correction such that amplitudes of the current command values of the three phases do not exceed a specified value in a case where a maximum amplitude value among the amplitude values of the three phases exceeds the specified value which is defined in advance.

2. The control device according to claim 1, wherein
the amplitude correction circuitry performs the correction by multiplying the current command values of the three phases by a reciprocal of the maximum amplitude value.

3. The control device according to claim 1, wherein
the amplitude correction circuitry performs the correction by multiplying the positive sequence current command values of the three phases and the negative sequence current command value of the three phases by a reciprocal of the maximum amplitude value.

4. The control device according to claim 1, wherein
the amplitude correction circuitry performs the correction by multiplying the positive sequence d-axis current command value, the positive sequence q-axis current command value, the negative sequence d-axis current command value, and the negative sequence q-axis current command value by a reciprocal of the maximum amplitude value.

5. The control device according to claim 1, wherein
the amplitude correction circuitry
calculates feedback amplitude values as amplitude values of current measurement values of the three phases from a positive sequence d-axis current measurement value, a positive sequence q-axis current measurement value, a negative sequence d-axis current measurement value, and a negative sequence q-axis current measurement value, and
further corrects the amplitudes of the current command values of the three phases so as to cancel differences between the corrected amplitudes of the current command values of the three phases and the feedback amplitude values.

6. A power conversion device comprising:
the control device according to claim 1; and
the inverter.

7. A control method for a power conversion device, the control method comprising:
performing two-phase to three-phase conversion for a positive sequence d-axis current command value and a positive sequence q-axis current command value to output positive sequence current command values of three phases;
performing the two-phase to three-phase conversion for a negative sequence d-axis current command value and a negative sequence q-axis current command value to output negative sequence current command values of the three phases;
adding the positive sequence current command values of the three phases and the negative sequence current command values of the three phases to output current command values of the three phases;
controlling an inverter based on the current command values of the three phases;
calculating amplitude values of the three phases from the positive sequence d-axis current command value, the positive sequence q-axis current command value, the negative sequence d-axis current command value, and the negative sequence q-axis current command value; and
performing correction such that amplitudes of the current command values of the three phases do not exceed a specified value in a case where a maximum amplitude value among the amplitude values of the three phases exceeds the specified value which is defined in advance.

8. A non-transitory computer-readable storage medium including computer executable instructions, wherein the instructions, when executed by a processor of a control device, cause the the processor of the control device to perform a method, the method comprising:
performing two-phase to three-phase conversion for a positive sequence d-axis current command value and a positive sequence q-axis current command value to output positive sequence current command values of three phases;
performing the two-phase to three-phase conversion for a negative sequence d-axis current command value and a negative sequence q-axis current command value to output negative sequence current command values of the three phases;
adding the positive sequence current command values of the three phases and the negative sequence current command values of the three phases to output current command values of the three phases;
controlling an inverter based on the current command values of the three phases;
calculating amplitude values of the three phases from the positive sequence d-axis current command value, the positive sequence q-axis current command value, the negative sequence d-axis current command value, and the negative sequence q-axis current command value; and
performing correction such that amplitudes of the current command values of the three phases do not exceed a specified value in a case where a maximum amplitude value among the amplitude values of the three phases exceeds the specified value which is defined in advance.
